(19) United States
(12) Patent Application Publication
(10) Pub. No.: US 2026/0352021 A1
(43) Pub. Date: Nov. 5, 2026

(54) PERSONAL CARE PRODUCT SYSTEM

(71) Applicant: The Gillette Company LLC, Boston, MA (US)

(72) Inventors: Alexander Hiller, Kronberg (DE); Robert Schaefer, Frankfurt (DE)

(21) Appl. No.: 19/666,880

(22) Filed: May 4, 2026

Related U.S. Application Data
(60) Provisional application No. 63/799,938, filed on May 5, 2025.

(51) Int. Cl. H02J 50/10; A45D 27/29; B26B 21/40; B26B 21/52; H02J 7/70

(52) U.S. Cl. CPC H02J 50/10; A45D 27/29; H02J 7/731; B26B 21/405; B26B 21/526

(57) ABSTRACT

A personal care product system with a stand. A stand inductive charging coil is positioned within the stand. The stand has an inductive charging coil with a coil axis. A handle is removably mounted to the stand. A power source is positioned within the handle. A handle inductive charging coil is positioned within the handle. The stand inductive charging coil is configured to generate a magnetic field that penetrates the handle inductive charging coil to charge the power source. A stand flux guiding member is positioned within the stand. The stand flux guiding member has a base and a leg extending from the base toward the handle inductive charging coil. The leg is positioned within the stand inductive charging coil. The base has a first end face that intersects the charging coil axis at an angle of about 20 degrees to about 70 degrees.

### FIELD

The present disclosure provides for a docking and charging system for a personal care product.

### BACKGROUND

Personal care products include dry shaving razors and wet shaving razors, among other types of grooming and hygiene-related implements. Some personal care products include powered elements, such as fluid pumps, motors, sensors, vibrating or oscillating components, heating elements, LEDs and so forth, which receive power from an onboard rechargeable power source, such as a battery. For a personal care product that has a rechargeable power source, the personal care product is typically connected to a power supply between uses so that the rechargeable power source can be replenished. A stand may be used to receive and charge the personal care product. The stand may be connected to an external power source, such as a wall outlet, that supplies power to charging coil. The personal care product may have a receiving coil that takes power from the charging coil to charge a power source positioned within the personal care product.

Personal care products with a rechargeable power source have charging modules that include various components, such as charge coils, mounting clips, leads, and the like, which are typically positioned internal to the product. An important feature of inductive chargers is to guide the magnetic energy of the charger coil in the direction of the receiver coil to decrease losses and unintended interaction to adjacent parts. Due to the form factor of various types of personal care products and other physical limitations, very limited internal space may be available for positioning the needed charging components. As such, in order to accommodate the various charging components, the size of the personal care product may need to be undesirably increased to enlarge the internal space, or the position of components of the charging module may need to be adjusted and/or reduced in size.

Further, for personal care products that utilize inductive charging systems with a docking magnet to hold the personal care product within the stand, the magnetic fields generated by the docking magnet(s) may decrease the efficacy of the inductive charging system. In order to mitigate undesirable interference from the magnetic fields of the docking magnets, the distance between the docking magnets and various components of the inductive charging system may be increased. However, increasing this distance may limit options with regard to how the personal care product can be docked to the energized stand or otherwise undesirably impact the design or operation of the personal care product.

Thus, it would be advantageous to provide for a personal care product and charging system that addresses one or more of these issues. Indeed, it would be advantageous to provide for a personal care product that can internally accommodate an inductive charging system while also maintaining a relatively small form factor. It would be advantageous to also provide for an energized stand that can internally accommodate an internal charging module while maintaining a desired form factor. It would be further advantageous to provide for charging modules that are able to maximize charging efficiency and minimize undesirable interference. It would also be advantageous to provide for a personal care product docking and charging system that improves the efficiency of an inductive charging system by minimizing unwanted interference.

### SUMMARY

The present disclosure fulfills the needs described above by, in one embodiment, providing a personal care product system with a stand. A stand inductive charging coil is positioned within the stand. The stand has an inductive charging coil with a coil axis. A handle is removably mounted to the stand. A power source is positioned within the handle. A handle inductive charging coil is positioned within the handle. The stand inductive charging coil is configured to generate a magnetic field that penetrates the handle inductive charging coil to charge the power source. A stand flux guiding member is positioned within the stand. The stand flux guiding member has a base and a leg extending from the base toward the handle inductive charging coil. The leg is positioned within the stand inductive charging coil. The base has a first end face that intersects the charging coil axis at an angle of about 20 degrees to about 70 degrees.

In another embodiment, a personal care product system having a stand. A stand inductive charging coil positioned within the stand. The stand inductive charging coil has a coil axis. A handle is removably mounted to the stand. A power source is positioned within the handle. A handle inductive charging coil positioned within the handle, the stand inductive charging coil is configured to generate a magnetic field that penetrates the handle inductive charging coil to charge the power source. A stand flux guiding member is positioned within the stand. The stand flux guiding member has a base and a leg extending from the base. The leg is positioned within the stand inductive charging coil. The base has a first end face and a second end face, wherein the first end face and the second end face are not parallel.

### BRIEF DESCRIPTION OF THE DRAWINGS

The above-mentioned and other features and advantages of the present disclosure, and the manner of attaining them, will become more apparent, and the disclosure itself will be better understood by reference to the following description of nonlimiting embodiments of the disclosure taken in conjunction with the accompanying drawings, wherein:

FIG. 1 is a perspective view of an exemplary personal care product system in accordance with one nonlimiting embodiment of the present disclosure.

FIG. 2 is a front view of a personal care product of FIG. 1 with a battery cap removed for clarity of illustration.

FIG. 3 is an enlarged perspective view of the personal care product system of FIG. 1 with the battery cover of the personal care product removed and a cover of the stand removed for clarity of illustration.

FIG. 4 is a perspective view of the stand of FIG. 1 with a cover of the stand removed for clarity of illustration.

FIG. 5 is a top, perspective view of one non-limiting example of a stand flux guiding member.

FIG. 6 is a side view of the stand flux guiding member of FIG. 5 including an inductive charging coil.

FIG. 7 is a side view of one non-limiting example of a stand flux guiding member including an inductive charging coil.

FIG. 8 is a side view of one non-limiting example of a stand flux guiding member including an inductive charging coil.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DETAILED DESCRIPTION

The present disclosure provides for personal care product systems having a handle and a stand for docking and charging the handle when not in use. Various nonlimiting embodiments of the present disclosure will now be described to provide an overall understanding of the principles of the function, design, and operation of the personal care product systems. One or more examples of these nonlimiting embodiments are illustrated in the accompanying drawings. Those of ordinary skill in the art will understand that the methods described herein and illustrated in the accompanying drawings are nonlimiting example embodiments and that the scope of the various nonlimiting embodiments of the present disclosure are defined solely by the claims. The features illustrated or described in connection with one nonlimiting embodiment may be combined with the features of other nonlimiting embodiments. Such modifications and variations are intended to be included within the scope of the present disclosure.

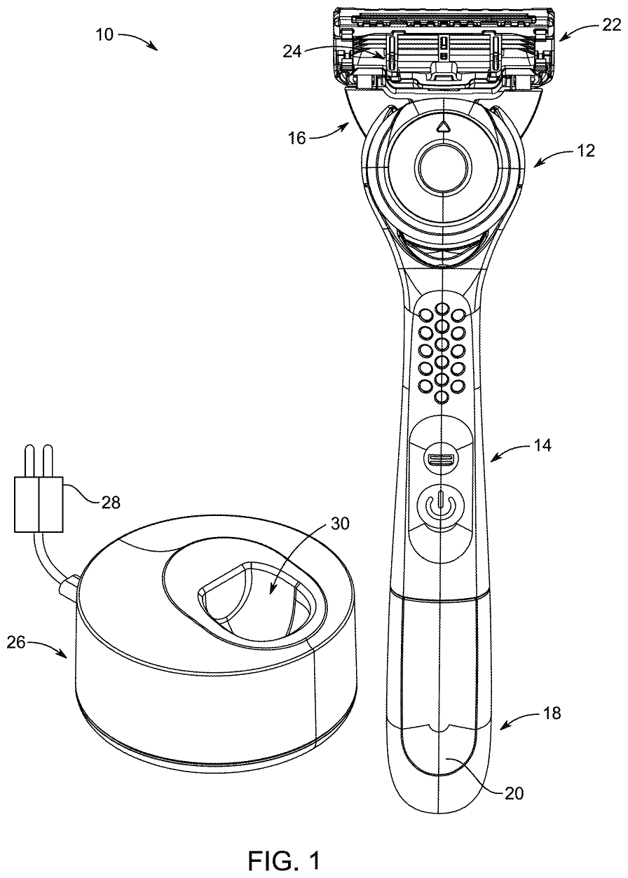

Referring now to FIG. 1, is a perspective view of an exemplary personal care product system 10 is depicted in accordance with one nonlimiting embodiment of the present disclosure. The personal care product system 10 may include a personal care product 12. It is understood that although the personal care product 12 is shown as a wet shaving razor, such depiction is for illustrative purposes only. Other examples of personal care products may include, without limitation, dry razors, epilators or other hair cutting and/or epilating household devices, trimmers, personal groomers, toothbrushes, light based hair removal devices, and so forth. The personal care product 12 may include a handle 14 having a first end 16 and a second end 18. The handle 14 may include one or more powered elements, such as LEDs, fluid pumps, motors, sensors, vibrating or oscillating components, heating elements, and so forth. A battery cap 20 may be removably mounted to the second end 18 to allow for removal of a power source (not shown) positioned within the handle 14.

It is understood that while a shaving razor cartridge 22 having one or more blades 24 is depicted as being coupled to the first end 16 of the handle 14, in other embodiments the handle 14 may additionally or alternatively include other types of personal care devices mounted to the handle 14, such as perforated shaving foils, rotary cutters, oscillating cutters, trimmers, toothbrushes, and so forth. Accordingly, the handle 14 with the depicted shaving razor cartridge 22 coupled to the first end 16 is for illustrative purposes only and is not intended to limit the disclosure to any particular configuration of the handle 14, the personal care product system 10, or the personal care product 12. The shaving razor cartridge 22 (or other type of attachment or fixed implement) may be fixedly or pivotably mounted to the handle 14, depending on the overall desired cost and performance. The shaving razor cartridge 22 may be permanently attached or removably mounted to the handle 14. The shaving razor cartridge 22 may include the one or more blades 24, or other cutting instruments.

The personal care product system 10 may include the personal care product 12 and a stand 26 that is configured to receive at least a portion of the handle 14 of the personal care product 12. The stand 26 may include a power plug 28 that is configured to mate with an external power source, such as a wall outlet. While the power plug 28 is shown in FIG. 1 as being a conventional wall plug, in other configurations different power plug configurations can be used, such as USB chargers, for example. The power plug 28 can be either permanently or removably attached to the stand 26. In removably attached configurations plug and socket combinations may include standardized connector configurations including but not limited to USB connectors and/or customized connectors. The handle 14 is shown in an un-docked position in FIG. 1. The stand 26 may define a recess 30 that is dimensioned to receive the second end 18 of the handle 14. As will be described in greater detail below, an inductive charging system (not shown) positioned within stand 26 may charge the personal care product 12 when the handle 14 is docked to the stand 26 (e.g., the second end is placed within the recess 30).

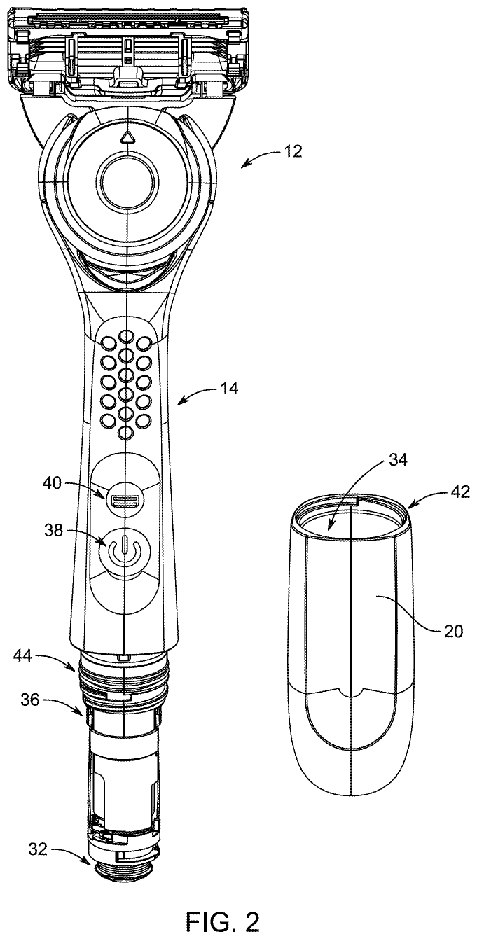

Referring to FIG. 2, a front view of the personal care product 12 of FIG. 1 is illustrated with the battery cap 20 removed for clarity of illustration. The personal care product 12 may include a handle inductive charging coil 48 positioned within the handle 14. For example, the handle inductive charging coil 32 may be positioned within an opening 34 define by the battery cap 20. The handle inductive charging coil 32 may facilitate the charging of a power source 36, such as a rechargeable battery. For example, NiCd (Nickel-Cadmium), NiMH (Nickel-Metal Hydride), Li-ion (Lithium Ion), LiFePO₄, or sodium-ion rechargeable batteries may be used. It is understood that the power source 36 may also include capacitors and super capacitors. In certain embodiments, the handle 14 may include a power button 38 that activates an electrical function of the handle 14 including but not limited to one or more LEDs 40 positioned on the handle 14. The battery cap 20 may be removably secured to the handle 14. For example, the battery cap 20 may define one or more locking members 42, such as threads, that engage one or more corresponding locking members 44, such as threads, on the handle 14.

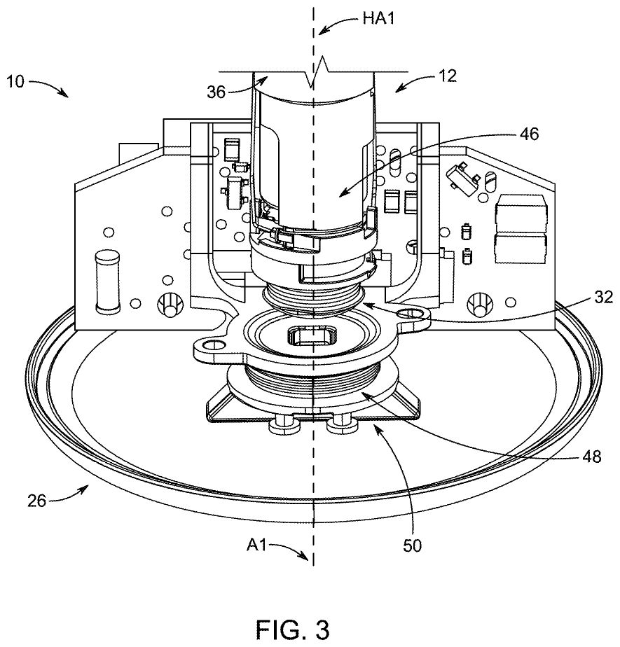

Referring to FIG. 3, an enlarged perspective view of the personal care product system 10 is shown with the handle 14 in a docked position. For example, the second end 18 of the handle 14 is positioned within the recess 30 of the stand 26 (FIG. 1). FIG. 3 is illustrated with an outer portion of the stand 26 and the battery cover 20 (FIG. 1) of the personal care product 12 removed for clarity of illustration. The personal care product 12 may include a handle charging module 46 (e.g., the handle inductive charging coil 32) that is configured to receive power from a stand inductive charging coil 48 that is wrapped around a stand flux guiding member 50 when the handle 14 is docked to the stand 26. The handle charging module 46 can use the power received from the stand inductive charging coil 48 to recharge the power source 36. When the handle 14 is in the docked position, the stand inductive charging coil 48 (i.e., a transmitter) and the handle inductive charging coil 32 (i.e., a receiver) magnetically couple such that a magnetic flux from the transmitter penetrates the receiver before returning to the transmitter via a return path. Since the handle inductive charging coil 32 is electrically coupled to the power source 36, the power source 36 may be recharged while the handle 14 is in the docked position through this inductive charging process.

Besides penetrating the handle inductive charging coil 32, the magnetic field generated during inductive charging can potentially also penetrate other components positioned within the handle 14. Additionally, the stray magnetic field can cause noise in conductive materials (e.g., integrated circuits, printed circuit board traces, etc.) and create electromagnetic interference issues. The stray magnetic field can also cause eddy currents in conductive objects, which can generate heat and decrease the magnetic field strength and the charging efficiency. The stand flux guiding member 50 may be configured to mitigate various undesirable side effects of inductive charging. The stand flux guiding member 50 may comprise a magnetic material that allows them to influence the magnetic field and the direction of the magnetic flux in its environment. A material such as ferrite, for instance, have a greater permeability to a magnetic field than air and therefore concentrates the magnetic field lines. By strategic placement and design of the stand flux guiding member 50, the magnetic field associated with the inductive charging can be concentrated and shaped, such that the efficiency of the inductive charging system is improved and undesirable coupling effects with other components of the handle 14 and the stand 26 are reduced. Further, the stand flux guiding member 50 may screen or otherwise guide the flux from external sources that may produce magnetic fields that penetrate the handle inductive charging coil 32.

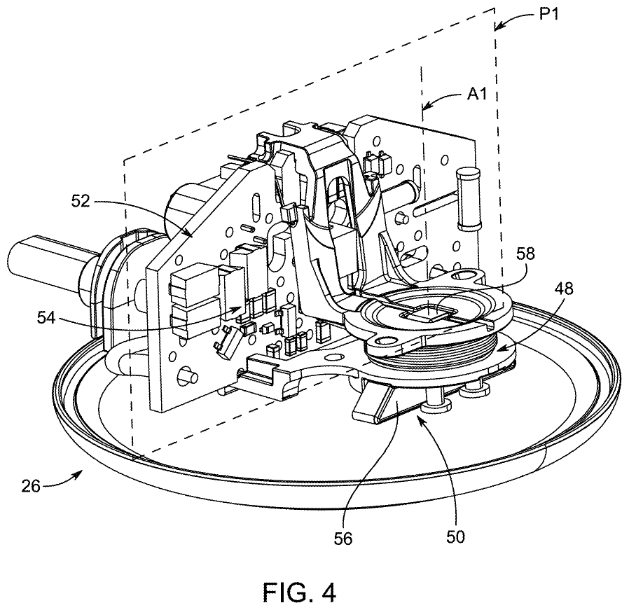

Referring to FIG. 4, a perspective view of the stand 26 of FIG. 3 is illustrated, with the outer cover of the stand 26 remove for clarity. A printed circuit board 52 may be positioned within the stand 26. The printed circuit board 52 may have a plurality of electrical components 54 (e.g. transistors, resistors, capacitors, LEDs, sensors, and/or relays). Stray magnetic fields generated from stand inductive charging coil 48 and/or the handle inductive charging coil 32 can cause electromagnetic interference issues with the electrical components 54 or conductive tracks on the printed circuit board. In certain embodiments, the stand inductive charging coil 48 has a coil axis A1 that is generally parallel to a plane P1 of the printed circuit board 52. For example, the coil axis A1 may be within 45 degrees, 25 degrees or preferably 10 degrees of being parallel to the plane P1 of the printed circuit board 52.

The orientation of the coil axis A1 and the plane P1 of the printed circuit board 52 may help minimize electromagnetic interference issues. As will be described in greater detail below, the stand flux guiding member 50 may include a base 56 and a leg 58 extending from the base 56. The base 56 may extend generally parallel to the plane P1 of the printed circuit board 52. The leg 58 may be positioned within the stand inductive charging coil 48. The handle inductive charging coil 32 may have a handle coil axis HA1 (FIG. 3). The handle coil axis HA1 (FIG. 3) may extend through a center of the handle inductive charging coil 32. The coil axis A1 may be generally aligned with handle coil axis HA1to facilitate charging of the power source 36.

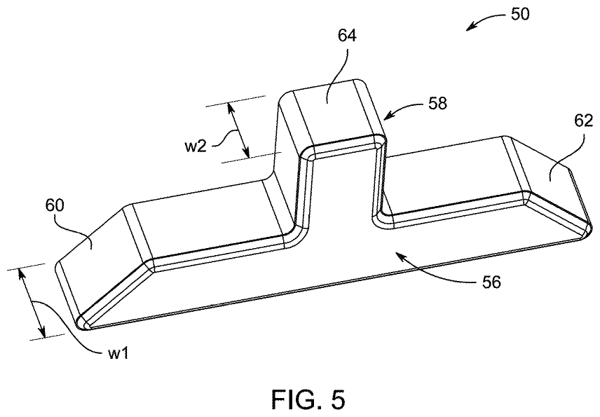

Referring to FIG. 5, a top, perspective view of one non-limiting example of the stand flux guiding member 50 is illustrated. The leg 58 may extend perpendicular from the base 56. In certain embodiments, the stand flux guiding member 50 may be generally “T” shaped. The base 56 and/or the leg 58 may be rectangular prism shaped. Other shapes are also possible for the base 56 and/or the leg 58 such as triangular, pentagonal, hexagonal, circular cross sections or any combination thereof. The base 56 may include a first end face 60 and a second end face 62. The leg 58 may have a top face 64. The first end face 60 and the second end face 62 may not be parallel to each other. In certain embodiments, a cross sectional area of the base 56 may be similar to a cross sectional area of the leg 58. For example, the cross sectional area of the leg 58 may be within 50%, 30% or 10% of the cross sectional area of the base 56. The base 56 may have a width “w1” of about 2 mm to about 5 mm. The leg 58 may have a width “w2” that is similar to “w1”. For example, the width “w2” may be within 50%, 30% or 10% of the width “w1”. Accordingly, the base 56 and/or the leg 58 may be about 4 mm² to about 25 mm².

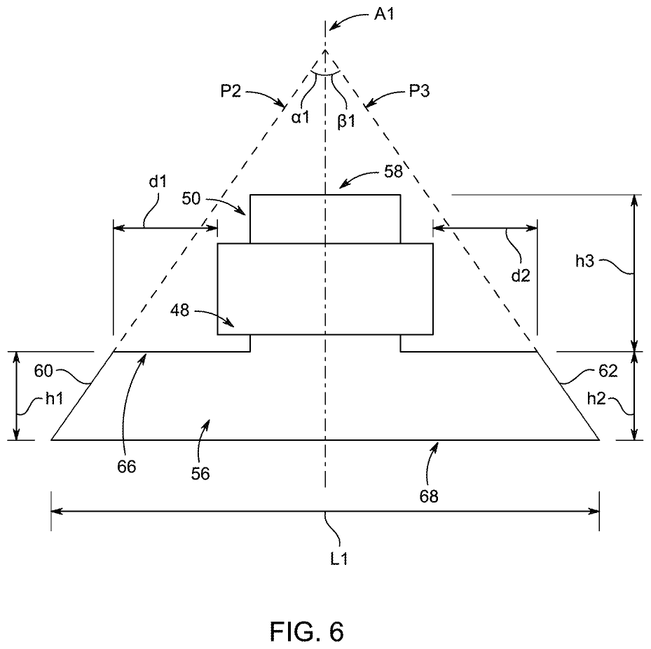

Referring to FIG. 6, a side view of the stand flux guiding member 50 is illustrated with the stand inductive charging coil 48 wrapped around the leg 58. It is understood the stand inductive charging coil 48 may not be directly wrapped around the leg 58. For example, the stand inductive charging coil 48 may be wrapped around an intermediate component, such as a bobbin. The stand inductive charging coil 48 may be positioned between the first end face 60 and the second end face 62. In certain embodiments, the stand inductive charging coil 48 may not extend beyond the first end face 60 and/or the second end face 62. For example, the stand inductive charging coil 48 may be spaced apart from the first end face 60 by a distance “d1” of 0 mm to about 10 mm and the second end face 62 by a distance “d2” of 0 mm to about 10 mm. In other embodiments, the stand inductive charging coil 48 may extend past where a top face 66 of the base 56 and the first end face 60 meet but may not extend past where a bottom face 68 of the base 56 and the first end face 60 meet. Similarly, inductive charging coil 48 may extend past where the top face 66 of the base 56 and the second end face 62 meet but may not extend past where the bottom face 68 of the base 56 and the second end face 62 meet. The location of the inductive coil for further embodiments explained below may have similar positioning as described above. If the inductive charging coil 48 extends too far, it may decrease charging efficiency.

In certain embodiments, the first end face 60 may extend along a plane P2 that intersects the coil axis A1 at an included angle α1 of about 20 degrees to about 70 degrees, preferably about 30 degrees to about 60 degrees and more preferably about 40 degrees to about 50 degrees. The second end face 62 may extend along a plane P3 that intersects the coil axis A1 at an included angle β1 of about 20 degrees to about 70 degrees. In certain embodiments the included angle β1 may be less than the angle α1. The included angle α1 and/or the included angle β1 may help direct the magnetic field and minimize interference. The base 56 may have a height “h1” of about 2 mm to about 5 mm. The height “h1” (measured at the first end face 60) and/or the height “h2” (measured at the second end face 62) may be approximately the same as the width “w1” shown in FIG. 5. For example, the height “h1” and/or the height “h2” may be within 50%, 30% or 10% of the width “w1”. The base 56 may have a length “L1” that is greater than a height “h3” of the leg 58.

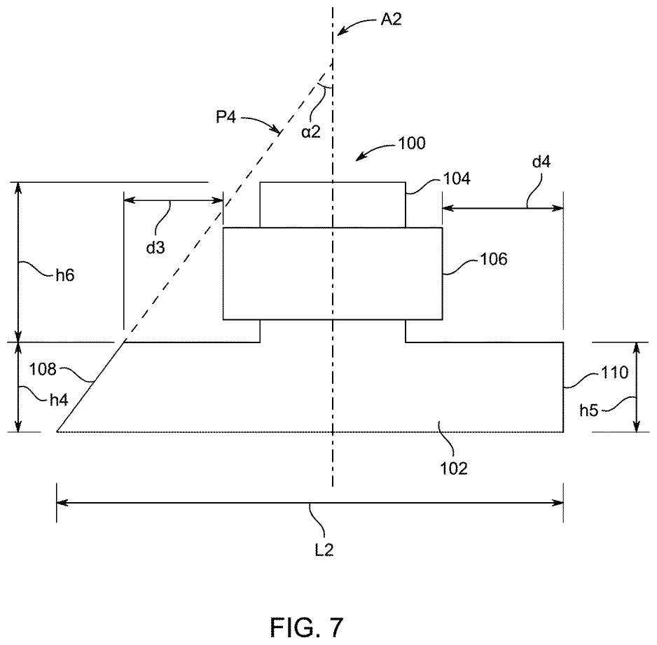

Referring to FIG. 7, a side view of another possible embodiment of a stand flux guiding member 100 is illustrated that may be incorporated into the stand 26 of FIG. 1. The stand flux guiding member 100 may include a base 102 and a leg 104 that extends generally perpendicular to the base 102. The base 102 and/or the leg 104 may be rectangular prism shaped. A stand inductive charging coil 106 wrapped around the leg 104. The stand inductive charging coil 106 may have a coil axis A2 extending through the center of the stand inductive charging coil 106. It is understood the stand inductive charging coil 106 may not be directly wrapped around the leg 104. For example, the stand inductive charging coil 106 may be wrapped around an intermediate component, such as a bobbin. The stand flux guiding member 100 may be similar to the stand flux guiding member 50 as described in FIG. 6 (e.g., generally “T-shaped”). However, the base 102 of the stand flux guiding member 100 may have a first end face 108 that is not parallel to the coil axis A2 and a second end face 110 that is parallel to the coil axis A2. The stand inductive charging coil 106 may be positioned between a first end face 108 and the second end face 110. In certain embodiments, the stand inductive charging coil 106 may be spaced apart from the first end face 108 by a distance “d3” of about 0 mm to about 10 mm and the second end face 110 by a distance “d4” of about 0 mm to about 10 mm. In certain embodiments, the first end face 108 may extend along a plane P4 that intersects the coil axis A2 at an included angle α2 of about 20 degrees to about 70 degrees, preferably about 30 degrees to about 60 degrees and more preferably about 40 degrees to about 50 degrees. The second end face 110 may extend parallel to the coil axis A2. The included angle α2 may help direct the magnetic field and minimize interference.

The base 102 may have a height “h4” of about 2 mm to about 5 mm. The height “h4” (measured at the first end face 108) and/or the height “h5” (measured at the end face 110) may be approximately the same as a width of the first end face 108 that is perpendicular to the height “h4” and/or the height “h5”. For example, the height “h4” and/or the height “h5” may be within 50%, 30% or 10% of the width that is perpendicular to the height “h4” and/or the height “h5”. The base 102 may have a length “L2” that is greater than a height “h6” of the leg 106.

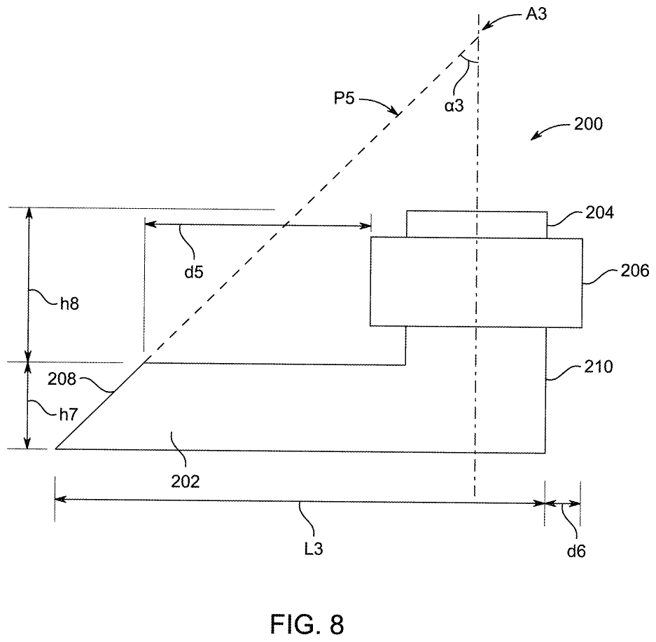

Referring to FIG. 8, a side view of another possible embodiment of a stand flux guiding member 200 is illustrated that may be incorporated into the stand 26 of FIG. 1. The stand flux guiding member 200 may be generally “L-shaped”. For the example, stand flux guiding member 200 may include a base 202 and a leg 204 that extends generally perpendicular to the leg 202. The base 202 and/or the leg 204 may be rectangular prism shaped. A stand inductive charging coil 206 wrapped around the leg 204. The stand inductive charging coil 206 may have a coil axis A3 extending through a center of the stand inductive charging coil 206. It is understood that the stand inductive charging coil 206 may not be directly wrapped around the leg 204. For example, the stand inductive charging coil 206 may be wrapped around an intermediate component, such as a bobbin. The base 202 of the stand flux guiding member 200 may have a first end face 208 that is not parallel to the coil axis A3 and a second end face 210 that is parallel to the coil axis A3. The leg 204 may extend from the second end face 210 to forming an L-shape. In certain embodiments, the stand inductive charging coil 206 may be spaced apart from the first end face 208 by a distance “d5” of about 0 mm to about 10 mm. In certain embodiments, the stand inductive charging coil 206 may overhang the second end face 210 by a distance “d6” of about 0 mm to about 10 mm. In certain embodiments, the first end face 208 may extend along a plane P5 that intersects the coil axis A3 at an included angle α3 of about 20 degrees to about 70 degrees, preferably about 30 degrees to about 60 degrees and more preferably about 40 degrees to about 50 degrees. The second end face 210 may extend parallel to the coil axis A2. The included angle α3 may help direct the magnetic field and minimize interference.

The base 20 may have a height “h7” of about 2 mm to about 5 mm. The height “h7” (measured at the first end face 208) may be approximately the same as a width of the first end face 208 that is perpendicular to the height “h7”. For example, the height “h7” may be within 50%, 30% or 10% of the width that is perpendicular to the height “h7”. The base 202 may have a length “L3” that is greater than a height “h8” of the leg 204.

### Representative Examples

A. A personal care product system comprising a stand; a stand inductive charging coil positioned within the stand, the stand inductive charging coil having a coil axis (A1); a handle removably mounted to the stand; a power source positioned within the handle; a handle inductive charging coil positioned within the handle, the stand inductive charging coil is configured to generate a magnetic field that penetrates the handle inductive charging coil to charge the power source; a stand flux guiding member positioned within the stand, the stand flux guiding member having a base and a leg extending from the base toward the handle inductive charging coil, the leg positioned within the stand inductive charging coil, the base has a first end face that intersects the coil axis at an included angle (a1) of 20 degrees to 70 degrees.
B. The personal care product system of paragraph A wherein the base is rectangular prism shaped.
C. The personal care product system of any one of paragraphs A-B wherein the leg is rectangular prism shaped.
D. The personal care product system of any one of paragraphs A-C wherein the base has a second end face and the stand inductive charging coil is positioned between the first end face and the second end face.
E. The personal care product system of any one of paragraphs A-D wherein the stand inductive charging coil is spaced apart from the first end face or the second end face by 0 mm to 10 mm.
F. The personal care product system of any one of paragraphs A-E wherein the leg has a cross sectional area that is within 50% of a cross sectional area of the base.
G. The personal care product system of any one of paragraphs A-F wherein stand flux guiding member is T shaped.
H. The personal care product system of any one of paragraphs A-F wherein the base has a width of 2 mm to 5 mm.
I. The personal care product system of any one of paragraphs A-H wherein the base has a length (L1) that is greater than a height (h3) of the leg.
J. The personal care product system of any one of paragraphs A-I further comprising a printed circuit board positioned within the stand and electrically connected to the stand inductive charging coil, wherein a plane (P1) defined by the printed circuit board is within 45 degrees parallel to the coil axis.
K. The personal care product system of any one of paragraphs A-J wherein the base has a second end face that extends along a plane (P3) that intersects the coil axis (A1) at an included angle (b1) of 20 degrees to 70 degrees.
L. The personal care product system of any one of paragraphs A-J wherein the stand flux guiding member is L-shaped.
M. The personal care product system of any one of paragraphs A-J wherein the base has a second end face that is parallel to the coil axis (A3).
N. The personal care product system of any one of paragraphs A-M wherein the included angle (a1) the first end face intersects the coil axis (A1) is 30 degrees to 60 degrees.
O. The personal care product system any one of paragraphs A-N wherein the included angle (a1) the first end face intersects the coil axis (A1) is 40 degrees to 50 degrees.

The dimensions and/or values disclosed herein are not to be understood as being strictly limited to the exact numerical dimensions and/or values recited. Instead, unless otherwise specified, each such dimension and/or value is intended to mean both the recited dimension and/or value and a functionally equivalent range surrounding that dimension and/or value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to anything disclosed or claimed herein or that it alone, or in any combination with any other reference or references, teaches, suggests or discloses anything disclosed or claimed herein. Further, to the extent that any meaning or definition of a term in this document conflicts with any meaning or definition of the same term in a document incorporated by reference, the meaning or definition assigned to that term in this document shall govern.

While particular forms of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A personal care product system comprising:
a stand;
a stand inductive charging coil positioned within the stand, the stand inductive charging coil having a coil axis;
a handle removably mounted to the stand;
a power source positioned within the handle;
a handle inductive charging coil positioned within the handle, the stand inductive charging coil is configured to generate a magnetic field that penetrates the handle inductive charging coil to charge the power source;
a stand flux guiding member positioned within the stand, the stand flux guiding member having a base and a leg extending from the base toward the handle inductive charging coil, the leg positioned within the stand inductive charging coil, the base has a first end face that intersects the coil axis at an included angle of 20 degrees to 70 degrees.

2. The personal care product system of claim 1 wherein the base is rectangular prism shaped.

3. The personal care product system of claim 1 wherein the included angle the first end face intersects the coil axis is about 40 degrees to about 50 degrees.

4. The personal care product system of claim 1 wherein the leg is rectangular prism shaped.

5. The personal care product system of claim 1 wherein the base has a second end face and the stand inductive charging coil is positioned between the first end face and the second end face.

6. The personal care product system of claim 1 wherein the stand inductive charging coil is spaced apart from the first end face or the second end face by 0 mm to 10 mm.

7. The personal care product system of claim 1 wherein the leg has a cross-sectional area that is within 50% of a cross-sectional area of the base.

8. The personal care product system of claim 1 wherein stand flux guiding member is T shaped.

9. The personal care product system of claim 6 wherein the base has a width of 2 mm to 5 mm.

10. The personal care product system of claim 1 wherein the base has a length that is greater than a height of the leg.

11-18. (canceled)

19. The personal care product system of claim 1 further comprising a printed circuit board positioned within the stand and electrically connected to the stand inductive charging coil, wherein a plane defined by the printed circuit board is within 45 degrees parallel to the coil axis.

20. (canceled)

21. The personal care product system of claim 1 wherein the base has a second end face that extends along a plane that intersects the coil axis at an included angle of 20 degrees to 70 degrees.

22. The personal care product system of claim 1 wherein the stand flux guiding member (200) is L-shaped.

23. The personal care product system of claim 1 wherein the base has a second end face that is parallel to the coil axis.
